(19) United States
(12) Patent Application Publication
(10) Pub. No.: US 2013/0039768 A1
(43) Pub. Date: Feb. 14, 2013

(54) ROTARY CONNECTION OF A ROTOR BLADE TO THE ROTOR HUB OF A WIND ENERGY PLANT

(71) Applicant: Uwe Iffland, Schweinfurt (DE)

(72) Inventor: Uwe Iffland, Schweinfurt (DE)

(73) Assignee: SCHAEFFLER TECHNOLOGIES AG & CO. KG, Herzogenaurach (DE)

(21) Appl. No.: 13/583,280

(22) PCT Filed: Mar. 2, 2011
(86) PCT No.: PCT/EP11/53068

§ 371 Date: Sep. 7, 2012

(30) Foreign Application Priority Data
Mar. 9, 2010 (DE) 10 2010 010 639.9

(51) Int. Cl. F03D 7/02

(52) U.S. Cl. 416/155

(57) ABSTRACT

The invention relates to a rotary connection of a rotor blade (2) to the rotor hub (3) of a wind energy plant, having a rotary mounting which is configured as a large anti-friction bearing (4) with a bearing inner ring (5) and a bearing outer ring (6), one bearing ring (5) of which rotary mounting is connected to the blade root (8) of the rotor blade (2), and the other bearing ring (6) of which rotary mounting is connected to the rotor hub (3), and having a blade-angle adjustment means which is configured as a gearwheel mechanism with a crown gear (15) which is embodied in sections and with a pinion which is connected to the drive shaft of an actuating motor, the crown gear (15) of which blade-angle adjustment means is arranged on one bearing ring (5), and the actuating motor of which blade-angle adjustment means is fastened to the component (3); which is connected to the other bearing ring (6). In order to reduce the production outlay and in order to improve the ease of servicing the rotary connection, it is provided that the crown gear (15) is a constituent part of a separate annular-segment component (18) which is connected to the associated bearing ring (5) and/or to the component (2) which is connected to the bearing ring (5), and the circumferential dimension of which separate annular-segment component (18) corresponds largely to the angular range (17) of the toothing (16).

### FIELD OF THE INVENTION

The invention refers to a rotary connection of a rotor blade to the rotor hub of a wind energy plant, with a rotary bearing which is designed as a large slewing ring bearing with a bearing inner ring and a bearing outer ring, one bearing ring of the rotary bearing being connected to the blade root of the rotor blade and the other bearing ring of the rotary bearing being connected to the rotor hub, and with a blade angle adjuster which is designed as a geared drive with a gear ring of segmented design and a pinion which is connected to the drive shaft of an actuating motor, the gear ring of the geared drive being arranged on the one bearing ring and the actuating motor of the geared drive being fastened to the component which is connected to the other bearing ring.

### BACKGROUND OF THE INVENTION

Wind energy plants with a horizontal rotor axis customarily have a nacelle which via an azimuth pivot bearing is rotatably fastened on a tower which is anchored via a foundation in the earth. Rotatably mounted in the nacelle is a rotor shaft which on the input side is connected to a rotor hub, which is arranged outside the nacelle and in most cases carries three rotor blades, and on the output side is connected via a transmission or directly to an electric generator which is arranged within the nacelle. For controlling the rotational speed of the rotor and for shutting down the wind energy plant, which in strong wind is undertaken as overload protection and for the carrying out of maintenance and repair operations, the rotor blades are rotatably mounted around their longitudinal axis in the rotor hub. By rotating the rotor blades around their longitudinal axis into their feathered position the rotor becomes largely free of torque and by the action of resistance moments is braked until coming to a standstill automatically or by using a braking device. For the rotary bearing of the rotor blades on the rotor hub use is made of large slewing ring bearings, such as double-row deep groove ball bearings, which in each case have a bearing inner ring, a bearing outer ring and a plurality of rolling bodies which are arranged in a circumferentially distributed manner between the bearing rings. One of the two bearing rings is connected via a screw fastening to the blade root of the rotor blade and the other bearing ring is correspondingly connected to the rotor hub.

For blade angle adjustment, i.e. for rotating the rotor blades around their longitudinal axis in the respective pivot bearing, combined or individually acting actuating devices, e.g. in the form of linkage devices, can be used. In the present case, however, it is based on a particularly space-saving and inexpensive individual blade angle adjuster which for each rotor blade provides a geared drive with a gear ring of segmented design, i.e. only over a limited circumferential range, and a pinion which is connected to the drive shaft of an actuating motor which is preferably designed as an electric motor. The gear ring is arranged in each case on the one bearing ring, and the actuating motor is fastened in each case on the component, i.e. on the rotor hub or the rotor blade, which is connected to the other bearing ring,

Up to now, it has been customary in the case of such blade angle adjustment devices that the toothing of the gear ring is integrated into the correspondingly large-dimensioned bearing ring by milling and extends over the entire circumference, although the practically usable pivot range is limited only to about 90°. As a result of this, a largely automated and therefore inexpensive production of the toothing is possible. As a result, the deformations of the bearing ring brought about by surface hardening of the tooth flanks also prove to be small and rotationally symmetrical so that the necessary mechanical remachining, e.g. by dressing and fine grinding, is kept within limits.

A generic-type rotary connection of a rotor blade to the rotor hub of a wind energy plant is described in DE 196 34 059 C1. In the case of this known rotary connection, the rotary bearing is designed as a large slowing ring bearing, the bearing outer ring of which is screwed to the blade root of the rotor blade and the bearing inner ring of which is screwed to the rotor hub. The blade angle adjuster is designed as a geared drive with an internally toothed gear ring and a pinion which is connected to the drive shaft of an actuating motor, wherein the toothing of the gear ring is integrated into the bearing inner ring over the entire circumference, and the actuating motor is arranged within the blade root of the rotor blade and is screwed to a bearing flange of the blade root.

A further rotary connection of this type of a rotor blade to the rotor hub of a wind energy plant is known from WO 1999/023 384 A1. In the case of this rotary connection, the rotary bearing in all the embodiment variants is designed as a large sleeving ring bearing, the bearing inner ring of which is screwed to the blade root of the rotor blade and the bearing outer ring of which is screwed to the rotor hub. The blade angle adjuster of the embodiment variants according to FIGS. 2 and 3 there is designed as a geared drive with an internally toothed gear ring and a pinion which is connected to the drive shaft of an actuating motor, wherein the toothing of the gear ring is integrated into the bearing inner ring over the entire circumference, and the actuating motor is arranged within the rotor hub and is screwed to a bearing flange which is fixed on the hub.

The unnecessarily high weight as a result of the redundant toothing sections, however, is disadvantageous on fully toothed bearing rings. Moreover, in the event of a damaged toothing of the gear ring the exchange of the entire slewing ring bearing is necessary, which on account of the disassembly of the rotor blade in question, which is necessary for this, is extremely costly. In DE 196 34 059 C1, however, in claim 4 there, it is proposed that the corresponding internal toothing can also be designed as a toothed partial ring segment. Since further information for the design and arrangement of the toothed partial ring segment is not to be gathered from the printed publication in question, it must be assumed therefrom that the internal toothing in segments, like the full toothing which is depicted in FIG. 1 there, is a component part of the bearing inner ring or is integrated into this. Toothing which is integrated into a bearing inner ring only over a limited circumferential region, however, leads to an increased and, moreover, asymmetrical distortion of the bearing ring on account of the necessary heat treatment during the hardening of the tooth flanks, which entails increased cost in the mechanical remachining, e.g. by dressing and fine grinding. Moreover, in the event of damaged toothing of the gear ring of segmented design, as in the case of a fully toothed design, the exchange of the entire slewing ring bearing is also required.

### OBJECT OF THE INVENTION

The invention is therefore based on the object of proposing a rotary connection of a rotor blade to the rotor hub of a wind energy plant of the type referred to in the introduction, which enables the use of a gear ring of segmented design with a lower manufacturing cost and increased service friendliness.

### SUMMARY OF THE INVENTION

The invention is based on the knowledge that the gear ring of segmented design does not necessarily have to be a component part of one of the two bearing rings of the large slewing ring bearing, but can first of all be manufactured in a suitable way as a separate component and then connected to the bearing ring in question. As a result of this, the bearing ring in question can be of smaller dimensions without limitation to its rigidity, as a result of which a saving can be made in installation space and weight. Moreover, the service friendliness of the rotary connection is increased significantly since in the event of damage to the toothing the gear ring can now be exchanged without disassembly of the large slewing ring bearing and of the rotor blade.

The object of the invention is consequently achieved in conjunction with the features of the preamble of claim 1 by the gear ring being a component part of a separate ring segment component which is connected to the associated bearing ring and/or to the component which is connected to the bearing ring, and by its circumferential dimensions corresponding in the main to the angular range of the toothing.

The invention, therefore, is based on a rotary connection of a rotor blade to the rotor hub of a wind energy plant, which comprises a rotary bearing of the rotor blade in the rotor hub and blade angle adjustment of the rotor blade in relation to the rotor hub. The rotary bearing is designed as a large slewing ring bearing, with a bearing inner ring and a bearing outer ring, one bearing ring of which is connected to the blade root of the rotor blade and the other bearing ring of which is connected to the rotor hub. The blade angle adjuster is designed as a geared drive with a gear ring of segmented design and a pinion which is connected to the drive shaft of an actuating motor, the gear ring of the geared drive being arranged on the one bearing ring and the actuating motor of the geared drive being fastened to the component which is connected to the other bearing ring. By arranging the gear ring in a separate ring segment component the manufacture of the rotary connection is simplified and a saving is made in installation space and weight. As a result of this, the service friendliness of the rotary connection is also increased since in the event of damage to the toothing only the ring segment component has to be exchanged without disassembly of the large slewing ring bearing and the rotor blade.

Advantageous embodiments of the rotary connection according to the invention are the subject of claims 2 to 6.

For simplifying the assembly, it is expediently provided that the ring segment component is provided with through-holes which are arranged in a circumferentially distributed manner and that the associated bearing ring is provided with correspondingly arranged threaded holes for premounting of the ring segment component on the bearing ring by means of screws. As a result of this, the ring segment component, which is provided with the gear ring, can be premounted on the large stewing ring bearing and together with this can be inserted into the rotor hub and fastened to this.

For the loadable fastening of the ring segment component this is advantageously provided with through-holes which align with the through-holes of the associated bearing ring and are provided for the common connection of the ring segment component and the bearing ring to the relevant component, i.e. to the rotor hub or to the blade root of the rotor blade, by means of threaded bolts.

Since the usable pivot range of the rotor blades between the full-load position and the feathered position is about 90°, the circumferential dimension of the ring segment component and of the gear ring expediently corresponds to an angular range of between 90° and 120°.

For achieving a technically and economically effective manufacture of such ring segment components, these are advantageously cut out in each case from a component which was originally manufactured as a circumferentially fully toothed ring.

So as not having to accept any wastage as far as possible in the process, the circumferential dimension of the ring segment component of the gear ring preferably corresponds to an angular range of 90° or of 120°. In this case, a circumferentially fully toothed ring yields four or three toothed ring segment components without any wastage.

### BRIEF DESCRIPTION OF THE FIGURES

The invention is explained in more detail in the following text with reference to the attached drawing based on a preferred embodiment. In the drawing

FIG. 1 shows a bearing inner ring of a large slewing ring bearing with a toothed ring segment component in a perspective view,

FIG. 2 shows the bearing inner ring with the ring segment component according to FIG. 1 in an axial plan view according to the direction of view A of FIG. 1,

FIG. 3 shows an enlarged radial sectional view of the bearing inner ring and of the ring segment component according to the line of intersection B-B of FIG. 2,

FIG. 4 shows an enlarged radial sectional view of the bearing inner ring and of the ring segment component according to the line of intersection C-C of FIG. 2,

FIG. 5 shows a known rotary connection of a rotor blade to the rotor hub of a wind energy plant in a sectional view, and

FIG. 6 shows an enlarged detailed view of the rotary connection according to FIG. 5 according to the detail D of FIG. 5.

### DETAILED DESCRIPTION OF THE DRAWINGS

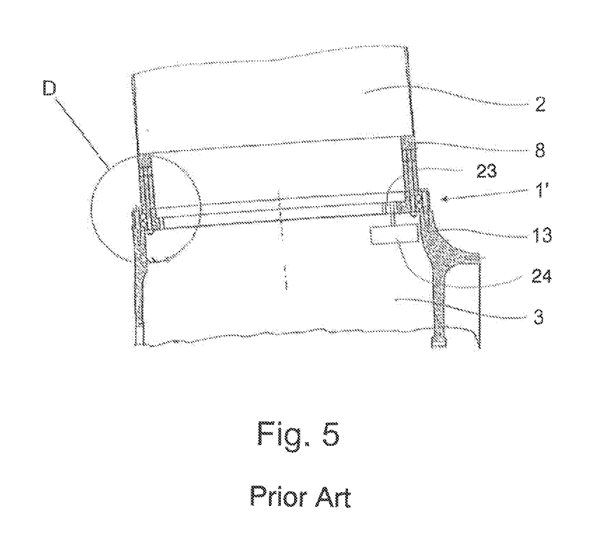

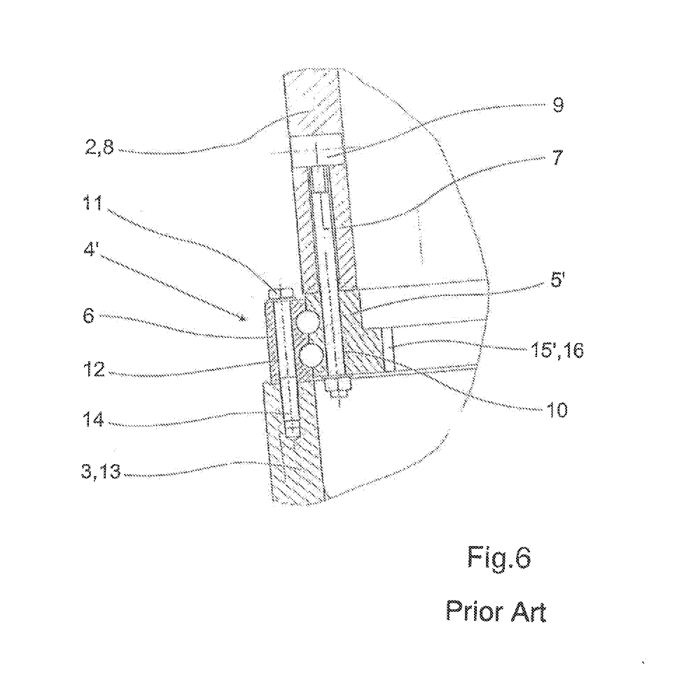

A known rotary connection 1 of a rotor blade 2 to the rotor hub 3 of a wind energy plant, which in FIG. 5 is shown in a sectional view and in FIG. 6 is shown in an enlarged detailed view according to detail D of FIG. 5, comprises a rotary bearing of the rotor blade 2 in the rotor hub 3 and a blade angle adjuster of the rotor blade 2 in relation to the rotor hub 3. The rotary bearing is designed as a large slewing ring bearing 4′ in the form of a double-row deep groove ball bearing with a bearing inner ring 5′ and a bearing outer ring 6. The bearing inner ring 5′ is screwed to the rotor blade 2 via a plurality of threaded bolts 7 which are inserted into threaded cross bolts 9 which are arranged in a circumferentially distributed manner in the blade root 8 of the rotor blade 2 and guided through corresponding through-holes 10 in the bearing inner ring 5′. The bearing outer ring 6 is screwed to the rotor hub 3 via a purality of bolts 11 which are guided through through-holes 12 which are arranged in a circumferentially distributed manner on the bearing outer ring 6, and inserted into corresponding threaded holes 14 arranged in the edge 13 of the housing of the rotor hub 3.

The blade angle adjuster is designed as a geared drive with a gear ring 15′ and a pinion which is connected to the drive shaft of an actuating motor. The gear ring 15′ in the present case is designed as internal toothing 16 which is integrated into the bearing inner rings 5′ and extends over the entire periphery. External toothing could also be provided, however. The actuating motor, which is not shown, the pinion of which is in permanent toothed engagement with the gear ring 15′, is arranged within the rotor hub 3 and fastened there at a suitable position.

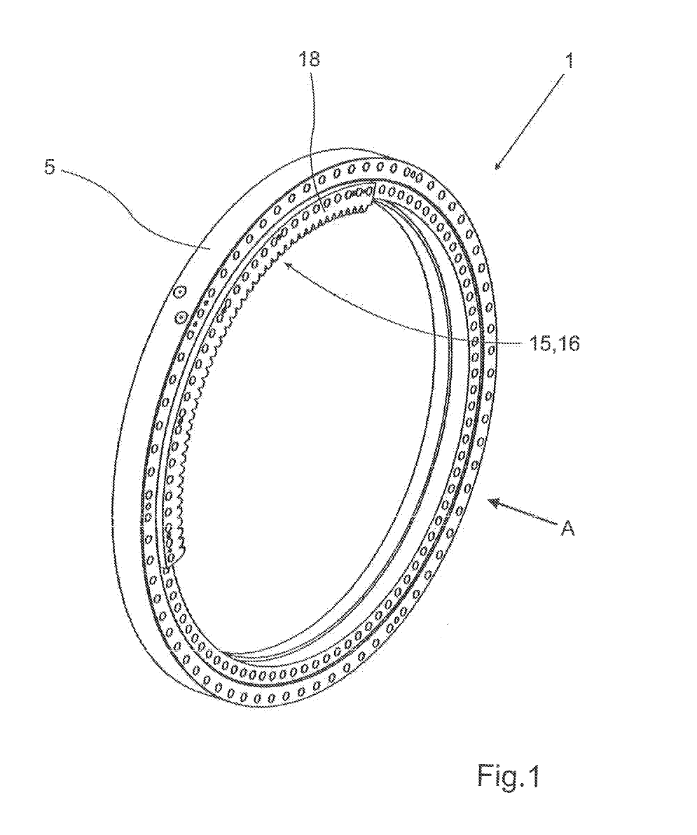

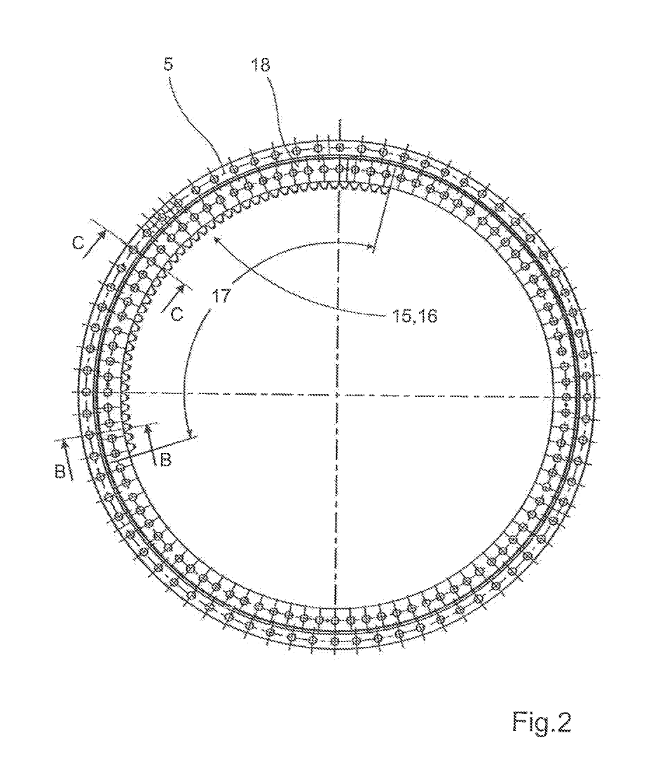

As can be seen in FIG. 1 in a perspective view of the bearing inner ring 5 and of the gear ring 15 and in FIG. 2 in an axial plan view according to the direction of view A of FIG. 1, the rotary connection 1 according to the invention differs from the described known solution by the fact that the gear ring 15 is constructed only over a limited circumferential angular region 17 of about 120° in the present case and is a component part of a separate ring segment component 18 which is connected to the bearing inner ring 5 and the circumferential dimension of which corresponds in the main to the angular region 17 of the inner toothing 16.

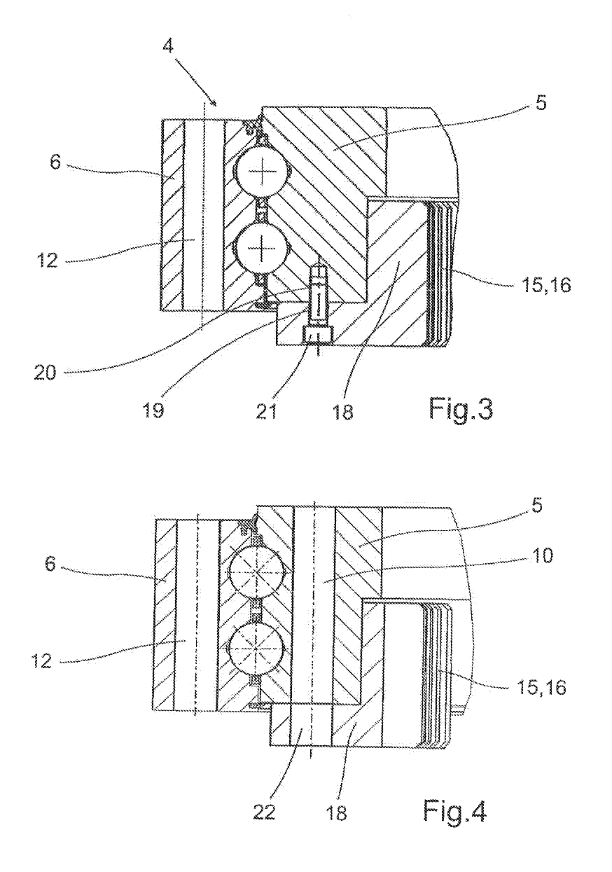

As can be seen in the enlarged sectional view shown in FIG. 3 according to the line of intersection B-B of FIG. 2, the ring segment component 18 is provided with through-holes 19 which are arranged in a circumferentially distributed manner and the bearing inner ring 5 is provided with correspondingly arranged threaded holes 20 for the premounting of the ring segment component 18 on the bearing inner ring 5 by means of screws 21. As a result of this, the ring segment component 18, which is provided with the gear ring 15, can be premounted on the large slewing ring bearing and together with this can be inserted into the rotor hub 3 and fastened to this.

It can be seen in a circumferentially displaced, enlarged sectional view, shown in FIG. 4, according to the line of intersection C-C of FIG. 2 that the ring segment component 18 is provided with through-holes 22 which align with the through-holes 10 of the bearing inner ring 5 and are provided for the common connection of the ring segment component 18 and the bearing inner ring 5 to the blade root 8 of the rotor blade 2 by means of threaded bolts.

### LIST OF DESIGNATIONS

1, 1′ Rotary connection
2 Rotor blade
3 Rotor hub
4, 4′ Large slewing ring bearing
5, 5′ Bearing inner ring
6 Bearing outer ring
7 Threaded bolt
8 Blade root
9 Threaded cross bolt
10 Through-hole
11 Screw
12 Through-hole
13 Edge of housing
14 Threaded hole
15, 15′ Gear ring
16 Internal toothing
17 Circumferential dimension, angular range
18 Ring segment component
19 Through-hole
20 Threaded hole
21 Screw
22 Through-hole
A Direction of view
B-B Line of intersection
C-C Line of intersection
D Detail

1.-6. (canceled)

7. A rotary connection of a rotor blade to the rotor hub of a wind energy plant, comprising:
a rotary bearing designed as a large Mewing ring bearing having a bearing inner ring and a bearing outer ring, a first bearing ring of the bearing inner ring and the bearing outer ring being connectable to a blade root of the rotor blade and a second bearing ring of the bearing inner ring and the bearing outer ring being connectable to the rotor hub, and
a blade angle adjuster designed as a geared drive with a gear ring having a toothing with a limited circumferential angular region with an angular range that is less than an entire circle, and a pinion connected to an actuating motor,
the gear ring of the geared drive being arranged on the first bearing ring and the actuating motor of the geared drive being connected with the second bearing ring, the gear ring being a component part of a separate ring segment component connected to the first bearing ring or a component connected to the first bearing ring, and the circumferential dimension of the ring segment component corresponding substantially to the angular range of the toothily of the gear ring.

8. The rotary connection as claimed in claim 7, wherein the ring segment component is provided with through-holes arranged in a circumferentially distributed manner and the first bearing ring is provided with correspondingly arranged threaded holes for premounting of the ring segment component on the first bearing ring by threaded fasteners.

9. The rotary connection as claimed in claim 8, wherein the ring segment component is provided with through-holes which align with through-holes of the first hearing ring and are provided for the common connection of the ring segment component and the first hearing ring to one of the rotor blade or the rotor hub by fasteners.

10. The rotary connection as claimed in claim 7, wherein the circumferential dimension of the ring segment component and of the gear ring corresponds to an angular range of between 90° and 120°.

11. The rotary connection as claimed in claim 7, wherein the ring segment component is cut from a component originally manufactured as a circumferentially fully toothed ring.

12. The rotary connection as claimed in claim 11, wherein the circumferential dimension of the ring segment component and of the gear ring corresponds to an angular range of 90° or of 120°.
